(19) United States
(12) Patent Application Publication
(10) Pub. No.: US 2021/0300382 A1
(43) Pub. Date: Sep. 30, 2021

(54) TIRE STATE ESTIMATING DEVICE, CONTROL METHOD OF TIRE STATE ESTIMATING DEVICE, AND NON-TRANSITORY STORAGE MEDIUM

(71) Applicant: JTEKT CORPORATION, Osaka (JP)

(72) Inventors: Hiroyuki YAMAGUCHI, Nagakute-shi (JP); Hideki SUGIURA, Nagakute-shi (JP); Motohiro FUJIYOSHI, Nagakute-shi (JP); Yoshikazu HATTORI, Nagakute-shi (JP); Yuya INOUE, Nagaokakyo-shi (JP); Yoichiro SANKAI, Kashiwara-shi (JP); Mahito SHIBA, Yamatotakada-shi (JP); Takuya HONJYOU, Nara-shi (JP)

(73) Assignee: JTEKT CORPORATION, Osaka (JP)

(21) Appl. No.: 17/215,511

(22) Filed: Mar. 29, 2021

(30) Foreign Application Priority Data
Mar. 30, 2020 (JP) 2020-061620

(51) Int. Cl. B60W 40/068; B60W 30/18; B60W 40/12; B60W 40/064

(52) U.S. Cl. CPC B60W 40/068; B60W 40/064; B60W 40/12; B60W 30/18145

(57) ABSTRACT

A tire state estimating device includes an electronic control unit. The electronic control unit is configured to acquire generated force of a tire. The electronic control unit is configured to acquire a friction coefficient between the tire and a road surface. The electronic control unit is configured to derive a grip margin of the tire. The electronic control unit is configured to estimate a contact length of the tire in an uncontrolled drive state. The electronic control unit is configured to estimate a cornering power of the tire, based on the contact length of the tire that is estimated and the generated force of the tire that is acquired.

### CROSS-REFERENCE TO RELATED APPLICATION

This application claims priority to Japanese Patent Application No. 2020-061620 filed on Mar. 30, 2020, incorporated herein by reference in its entirety.

### BACKGROUND

### 1. Technical Field

The disclosure relates to a tire state estimating device, a control method of the tire state estimating device, and a non-transitory storage medium.

### 2. Description of Related Art

There is known a tire state estimating device that obtains a tire state including cornering power of a tire, in order to control braking and attitude of a vehicle, and improve traveling stability of the vehicle (see Japanese Unexamined Patent Application Publication No. 10-281944 (JP 10-281944 A), for example). In this technology, lateral force at the tire and sideslip angle of the tire are calculated using lateral acceleration of the vehicle, yaw rate, wheelbase, distances from the front and rear wheels to the center of gravity, and so forth, and the cornering power of the tire is obtained from the ratio of the lateral force and sideslip angle.

### SUMMARY

However, although the sideslip angle of the tire can be calculated by integrating the angular velocity of sideslip obtained from the lateral acceleration, the yaw rate, and vehicle speed, error is expected to occur due to a gravitational acceleration component from body roll of the vehicle, road surface cant, and so forth. Accordingly, the precision of the cornering power calculated using the sideslip angle of the tire that contains error will be lower. Also, the cornering power can be calculated more accurately using a sideslip angle calculated by measurement equipment, but this necessitates using a costly ground-speed meter to measure the sideslip angle, which is not desirable for application to individual vehicles. Accordingly, there is room for improvement in accurately finding cornering power of tires.

The disclosure can accurately estimate cornering power with a simple configuration.

A first aspect of the disclosure is a tire state estimating device. The tire state estimating device includes an electronic control unit. The electronic control unit is configured to acquire generated force of a tire. The electronic control unit is configured to acquire a friction coefficient between the tire and a road surface. The electronic control unit is configured to derive a grip margin of the tire, based on the generated force of the tire that is acquired and the friction coefficient that is acquired. The electronic control unit is configured to estimate a contact length of the tire, based on the generated force of the tire that is acquired and the grip margin that is derived, in an uncontrolled drive state, the uncontrolled drive state being a state in which, of the generated force of the tire, generated force generated in a front-rear direction of the tire is no greater than a threshold value set in advance. The electronic control unit is configured to estimate a cornering power of the tire, based on the contact length of the tire that is estimated, and the generated force of the tire that is acquired.

In the tire state estimating device, the electronic control unit may be configured to acquire, as the generated force of the tire, a self-aligning torque generated at the tire, a front-rear direction state generated at the tire, a lateral-direction state generated at the tire, and a load-on-wheel state generated at the tire. The electronic control unit may be configured to acquire a coefficient of static friction as a first friction coefficient, and a coefficient of dynamic friction as a second friction coefficient. The coefficient of dynamic friction may be a coefficient of dynamic friction in a moving state, in which the tire and the road surface are relatively moving, the coefficient of dynamic friction being derived using the front-rear direction state, the lateral-direction state, and the load-on-wheel state that are acquired. The electronic control unit may be configured to derive the grip margin of the tire based on a ratio of the first friction coefficient and the second friction coefficient. The electronic control unit may be configured to estimate the contact length of the tire based on the self-aligning torque, the front-rear direction state, the lateral-direction state, and the grip margin. The electronic control unit may be configured to estimate the cornering power of the tire based on the contact length of the tire that is estimated, the self-aligning torque, the front-rear direction state, the lateral-direction state, and the grip margin.

In the tire state estimating device, the electronic control unit may be configured to derive the cornering power of the tire using the following Expression

$$\begin{matrix} & ( Expression ) \\ {K}_{β} = [ \frac{{T}_{sat}}{L \cdot {F}_{y}} - \frac{2 \cdot ɛ}{1 + {ɛ}^{1 / 3} + {ɛ}^{2 / 3}} ] / [ \frac{3}{5} \cdot \frac{{F}_{x} \cdot ( 1 + 2 \cdot {ɛ}^{1 / 3} + 3 \cdot {ɛ}^{2 / 3} + 4 \cdot ɛ )}{{( 1 + {ɛ}^{1 / 3} + {ɛ}^{2 / 3} )}^{2}} ] & \end{matrix}$$

in which Tsat represents the self-aligning torque, Fx the front-rear direction state, Fy the lateral-direction state, ε the grip margin of the tire, and L the contact length of the tire.

In the tire state estimating device, the electronic control unit may be configured to estimate, regarding a plurality of different types of tires, a type of tire corresponding to the generated force that is acquired and the cornering power that is estimated, based on a correlative relation between generated force of each tire and cornering power of each tire, stored by type.

A second aspect of the disclosure is a control method of a tire state estimating device. The tire state estimating device includes a processor. The control method includes: acquiring generated force of a tire by the processor; acquiring a friction coefficient between the tire and a road surface by the processor; deriving a grip margin of the tire by the processor, based on the generated force of the tire that is acquired and the friction coefficient that is acquired; estimating a contact length of the tire by the processor, based on the generated force of the tire that is acquired and the grip margin that is derived, in an uncontrolled drive state, the uncontrolled drive state being a state in which, of the generated force of the tire, generated force generated in a front-rear direction of the tire is no greater than a threshold value set in advance; and estimating a cornering power of the tire by the processor, based on the contact length of the tire that is estimated, and the generated force of the tire that is acquired.

A third aspect of the disclosure is a non-transitory storage medium. The non-transitory storage medium stores instructions that are executable by one or more processors and that cause the one or more processors to perform functions of: acquiring generated force of a tire; acquiring a friction coefficient between the tire and a road surface; deriving a grip margin of the tire, based on the generated force of the tire that is acquired and the friction coefficient that is acquired; estimating a contact length of the tire, based on the generated force of the tire that is acquired and the grip margin that is derived, in an uncontrolled drive state, the uncontrolled drive state being a state in which, of the generated force of the tire, generated force generated in a front-rear direction of the tire is no greater than a threshold value set in advance; and estimating a cornering power of the tire, based on the contact length of the tire that is estimated, and the generated force of the tire that is acquired.

According to the above configuration, tire contact length can be accurately estimated with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a schematic configuration of a tire state estimating device according to a first embodiment;

FIG. 2 is a diagram illustrating an example of a schematic configuration of a tire contact length estimating unit;

FIG. 3 is a diagram illustrating an example of a correlative relation between a physical quantity indicating a ratio between a pneumatic trail value and a contact length of a tire, and a grip margin;

FIG. 4 is a diagram illustrating an example of a schematic configuration of a cornering power estimating unit;

FIG. 5 is a diagram illustrating an example of tire lateral force characteristics regarding tire slip angle;

FIG. 6 is a diagram illustrating an example of a tire state estimating device according to a configuration including a computer;

FIG. 7 is a flowchart showing an example of a flow of processing of a tire state estimating program 54P;

FIG. 8 is a diagram illustrating an example of cornering force characteristics as to tire sideslip angle by types of tires;

FIG. 9 is a diagram illustrating an example of cornering force characteristics as to tire sideslip angle by types of different loads on wheel;

FIG. 10 is a diagram illustrating an example of cornering power characteristics as to load on wheel by types of tires;

FIG. 11 is a diagram illustrating an example of a schematic configuration of a tire state estimating device according to a second embodiment; and

FIG. 12 is a diagram illustrating an example of a relation between a tire slip ratio and a friction coefficient.

### DETAILED DESCRIPTION OF EMBODIMENTS

Embodiments for realizing technology according to the present disclosure will be described below in detail, with reference to the drawings. In the embodiments, description will be made regarding a case in which the technology according to the present disclosure is applied to a tire state estimating device that estimates various types of states of tires installed on a vehicle while the vehicle is travelling. Note that components and processes of which operations and functions bear the same role may be denoted by the same signs through the drawings, and repetitive description may be omitted as appropriate.

### First Embodiment

A tire state estimating device 1 according to a first embodiment estimates cornering power of a tire as a tire state, while the vehicle is traveling.

In the present disclosure, the term “uncontrolled drive state” is a concept including the state of a tire within a generation range of tire generated force that is generated during stable traveling of the vehicle. An example of an uncontrolled drive state is the state of a tire regarding which longitudinal force of the tire generated during stable traveling of the vehicle is within a generation range (e.g., no greater than a threshold value set in advance). The vehicle travels straight or turns at a constant vehicle speed. Also, the term “controlled drive state” is a concept including states of the tire other than the uncontrolled drive state. An example is at least a state of the tire in which longitudinal force of the tire exceeds a generation range (e.g., a threshold value set in advance).

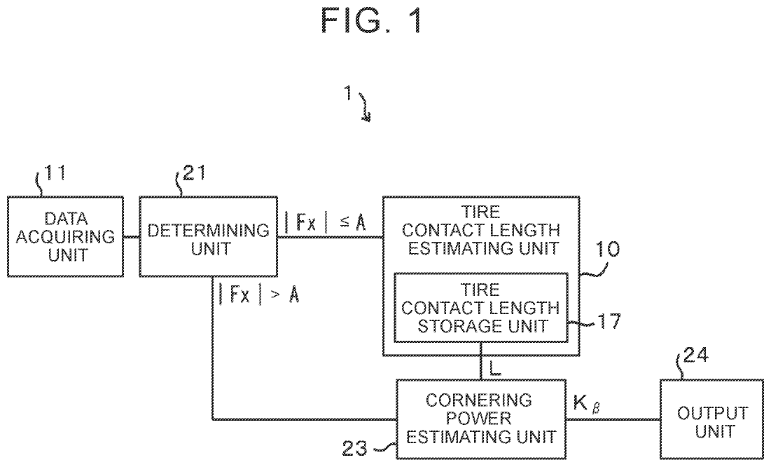

FIG. 1 illustrates an example of a schematic configuration of the tire state estimating device 1 according to the first embodiment. In the present embodiment, description will be made regarding a case in which cornering power is estimated with controlled drive when a vehicle is turning, as an example.

As illustrated in FIG. 1, the tire state estimating device 1 is provided with a tire contact length estimating unit 10, a data acquiring unit 11, a determining unit 21, a cornering power estimating unit 23, and an output unit 24. Note that the tire state estimating device 1 is an example of a tire state estimating device according to the present disclosure.

The data acquiring unit 11 is for acquiring various types of data relating to traveling of a vehicle (omitted from illustration). Examples of data acquired include data indicating each of friction coefficient between the road surface and the tire, and tire generated force. The determining unit 21 is for determining whether the state of the tire is an uncontrolled drive state, using the data acquired by the data acquiring unit 11. The tire contact length estimating unit 10 estimates a tire contact length L using the tire generated force while traveling. The cornering power estimating unit 23 estimates the cornering power, using the data acquired by the data acquiring unit 11 and the tire contact length L estimated by the tire contact length estimating unit 10. The output unit 24 outputs the cornering power estimated at the cornering power estimating unit 23.

Next, the parts of the tire state estimating device 1 will be described.

Data Acquiring Unit

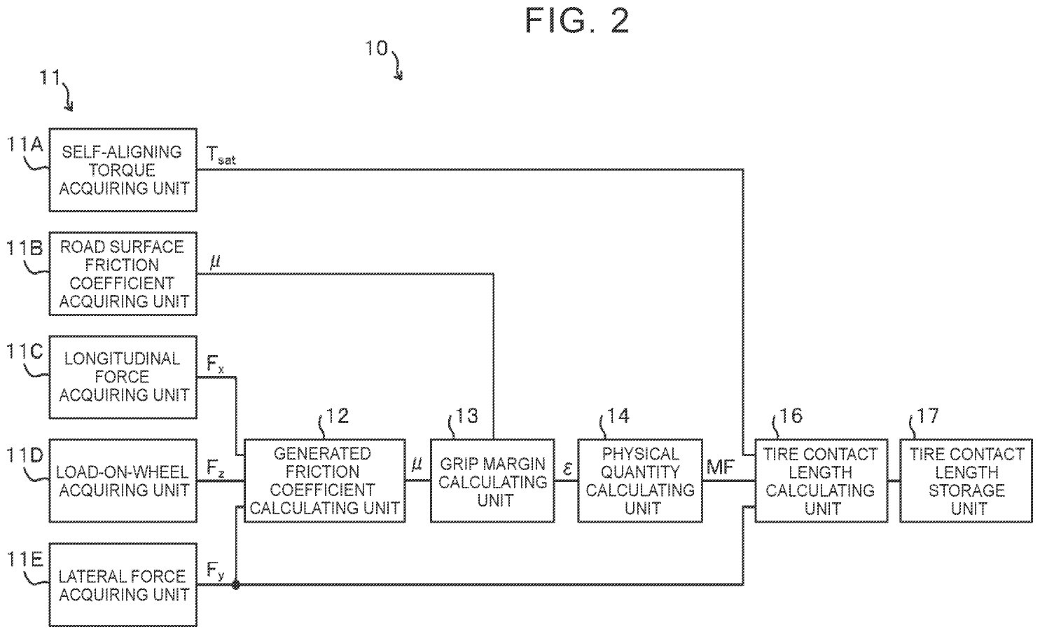

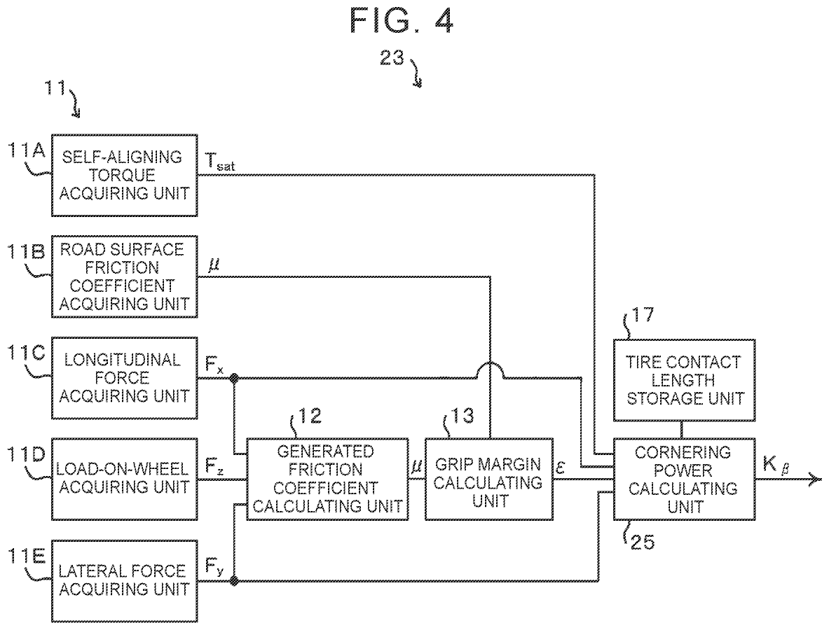

The data acquiring unit 11 acquires various types of data relating to traveling of the vehicle (omitted from illustration). Examples of acquired data include each of the friction coefficient between the road surface and the tire, and each of data of self-aligning torque, longitudinal force, load on wheel, and lateral force, as tire generated force. The data acquiring unit 11 includes a self-aligning torque acquiring unit 11A, a road surface friction coefficient acquiring unit 11B, a longitudinal force acquiring unit 11C, a load-on-wheel acquiring unit 11D, and a lateral force acquiring unit 11E (see FIGS. 2 and 4), to acquire this data. Note that the data acquiring unit 11 is an example of a generated force acquiring unit and a friction coefficient acquiring unit according to the present disclosure.

Determining Unit

The determining unit 21 determines at least whether the state of the tire is the uncontrolled drive state, using data acquired by the data acquiring unit 11. In the present embodiment, the tire is determined to be in the uncontrolled drive state when the longitudinal force of the tire as a tire state is no greater than a threshold value set in advance.

Specifically, conditions in which the longitudinal force Fx is a very small value no greater than a predetermined value (|Fx|≤A) are set in advance as threshold value conditions for the uncontrolled drive state, and the state is determined to be the uncontrolled drive state when the threshold value conditions are satisfied. That is to say, the determining unit 21 determines that the state is the uncontrolled drive state when the longitudinal force Fx of the tire is a very small value no greater than the predetermined value (|Fx|≤A). The constant A is the threshold value, and is a setting value set in advance as a value in the proximity of zero, around a sensor noise amplitude.

Note that the physical quantity used for determination by the determining unit 21 is not limited to data indicating the longitudinal force Fx of the tire. For example, the operation amount of an operating unit that instructs acceleration or deceleration, such as an accelerator pedal, a brake pedal, or the like, of the vehicle (omitted from illustration) may be used.

Also, the determining unit 21 preferably makes determination of whether turning conditions of the vehicle set in advance that would affect cornering power K_{β} are satisfied. The turning conditions for this vehicle are conditions that the lateral force Fy of the tire is greater than a predetermined value (|Fy|>Fyo). This predetermined value Fyo can be obtained by measurement in experimentation performed in advance, or obtained by simulation.

Tire Contact Length Estimating Unit

The tire contact length estimating unit 10 estimates the tire contact length L using the tire generated force while traveling. Specifically, the tire contact length estimating unit 10 estimates the tire contact length L using the tire generated force in the uncontrolled drive state while traveling.

FIG. 2 illustrates an example of a schematic configuration of the tire contact length estimating unit 10. As illustrated in FIG. 2, the tire contact length estimating unit 10 is provided with the data acquiring unit 11, a generated friction coefficient calculating unit 12, a grip margin calculating unit 13, a physical quantity calculating unit 14, a tire contact length calculating unit 16, and a tire contact length storage unit 17.

The tire contact length estimating unit 10 is able to acquire data from the data acquiring unit 11. The data acquiring unit 11 is for acquiring various types of data relating to traveling of the vehicle (omitted from illustration), and includes each of the self-aligning torque acquiring unit 11A, the road surface friction coefficient acquiring unit 11B, the longitudinal force acquiring unit 11C, the load-on-wheel acquiring unit 11D, and the lateral force acquiring unit 11E.

The self-aligning torque acquiring unit 11A detects or estimates self-aligning torque (Tsat) in the vehicle, and acquires data indicating the detected or estimated self-aligning torque (Tsat). The self-aligning torque acquiring unit 11A is able to acquire the self-aligning torque (Tsat) for each wheel provided to the vehicle.

The method of detecting or estimating the self-aligning torque is a known method, and accordingly detailed description will be omitted. An example is the technology described in Japanese Unexamined Patent Application Publication No. 2004-352048 (JP 2004-352048 A). Note that the self-aligning torque acquiring unit 11A may acquire data indicating the self-aligning torque (Tsat) from a detector installed in the vehicle that detects or estimates the self-aligning torque.

The road surface friction coefficient acquiring unit 11B acquires a known friction coefficient between the road surface and the tire at the current traveling time (i.e., traveling position). Data of the known friction coefficient (hereinafter referred to as road surface friction coefficient) can be obtained by acquiring data set in advance in accordance with the traveling state of the vehicle. For example, data of the road surface friction coefficient for a dry road may be stored in memory, and when the traveling state of the vehicle is under high temperatures and the windshield wipers are not in an operating state, the data of the road surface friction coefficient for a dry road, stored in the memory, may be acquired as the data for the road surface friction coefficient. Note that the road surface friction coefficient acquiring unit 11B is an example of a friction coefficient acquiring unit according to the present disclosure. The road surface friction coefficient is an example of a first friction coefficient indicating a coefficient of static friction according to the present disclosure.

Note that data of the road surface friction coefficient can be acquired from external devices from the vehicle, by communication such as, for example, vehicle-to-vehicle communication, road-to-vehicle communication, distribution communication, and so forth. For example, in vehicle-to-vehicle communication, the data of the road surface friction coefficient that has been detected by a vehicle traveling ahead can be acquired from a communication device installed in the vehicle traveling ahead. Also, in road-to-vehicle communication, data of the road surface friction coefficient can be acquired from a communication device that is installed on the road and transmits road conditions. Also, in distribution communication, data of the road surface friction coefficient can be acquired from distribution information of a cloud service that distributes data of a known road surface friction coefficient, road management information including data of a known road surface friction coefficient, or the like through a communication line and network communication.

The longitudinal force acquiring unit 11C, the load-on-wheel acquiring unit 11D, and the lateral force acquiring unit 11E acquire data indicating tire generated force from detectors installed in the vehicle. Specifically, the longitudinal force acquiring unit 11C acquires, of tire generated force, data of longitudinal force (Fx). The load-on-wheel acquiring unit 11D acquires data of load on wheel (Fz). The lateral force acquiring unit 11E acquires data of lateral force (Fy) occurring in the vehicle. Note that the data representing tire generated force can be acquired for each wheel provided to the vehicle.

Note that the self-aligning torque acquiring unit 11A is an example of a generated force acquiring unit that acquires the self-aligning torque according to the present disclosure. The data of the longitudinal force (Fx) is an example of a front-rear direction state according to the present disclosure, and the longitudinal force acquiring unit 11C is an example of a generated force acquiring unit that acquires the front-rear direction state according to the present disclosure. The data of the load on wheel (Fz) is an example of a load-on-wheel state according to the present disclosure, and the load-on-wheel acquiring unit 11D is an example of a generated force acquiring unit that acquires the load-on-wheel state in the present disclosure. The data of the lateral force (Fy) is an example of a lateral-direction state according to the present disclosure, and the lateral force acquiring unit 11E is an example of a generated force acquiring unit that acquires the lateral-direction state according to the present disclosure.

These detectors that detect these tire generated forces are known arrangements, and accordingly detailed description thereof will be omitted. For example, the longitudinal force (Fx), the load on wheel (Fz), and the lateral force (Fy) can each be detected by data or a combination of a plurality of pieces of data from an engine torque sensor, brake fluid sensor, yaw rate sensor, acceleration sensor such as a gravity (G) sensor or the like.

The generated friction coefficient calculating unit 12 calculates the friction coefficient between the road surface and the tire at the current traveling time (i.e., traveling position) from data of the tire generated force (hereinafter referred to as generated friction coefficient). The generated friction coefficient calculating unit 12 calculates the generated friction coefficient using data detected as the tire generated force (longitudinal force Fx, lateral force Fy, load on wheel Fz) at the current point in time. The generated friction coefficient can be calculated from the following Expression (1). Note that the generated friction coefficient calculating unit 12 is able to calculate the generated friction coefficient for each wheel provided to the vehicle. Also, the generated friction coefficient calculating unit 12 is an example of a friction coefficient deriving unit according to the present disclosure. Also, the generated friction coefficient corresponds to a second friction coefficient representing a coefficient of dynamic friction according to the present disclosure.

$$generated friction coefficient = \frac{\sqrt{{F}_{x}^{2} + {F}_{y}^{2}}}{{F}_{z}} \qquad ( 1 )$$

Note that the tire contact length estimating unit 10 estimates the tire contact length L in an uncontrolled drive state, and the effects of the longitudinal force Fx of the tire are miniscule and do not need to be taken into consideration. Accordingly, Expression (1) can be modified into the following Expression (1A).

$$generated friction coefficient = \frac{⌈ {F}_{y}^{2} ⌉}{{F}_{z}} \qquad ( 1 A )$$

The grip margin calculating unit 13 is for calculating a current grip margin ε. The current grip margin ε is calculated using the data of the road surface friction coefficient acquired by the road surface friction coefficient acquiring unit 11B and data indicating the generated friction coefficient calculated at the generated friction coefficient calculating unit 12. The grip margin ε represents, for example, how much of a margin the current braking force of the tire has as to the maximum braking force, and can be expressed as a proportion of the current grip force as to the maximum grip force. Computing this grip margin enables how much of a margin there is in grip force to be comprehended, and accordingly traveling stability of the vehicle can be improved. The grip margin 6 can be calculated by the following Expression (2). Note that the grip margin calculating unit 13 is able to calculate the grip margin 6 for each wheel that the vehicle is provided with. Also, the grip margin calculating unit 13 is an example of a grip margin deriving unit according to the present disclosure.

$$grip margin = 1 - \frac{generated friction coefficient}{road surface friction coefficient} \qquad ( 2 )$$

The physical quantity calculating unit 14 calculates a physical quantity MF that represents the ratio between the pneumatic trail value and the tire contact length L. Note that the physical quantity calculating unit 14 is able to calculate the physical quantity MF for each wheel that the vehicle is provided with.

Now, the self-aligning torque Tsat and the grip margin ε (i.e., ξₛ³) have the relation in the following Expression (3),

$${T}_{sat} = \{ ∠ \cdot \frac{2 \cdot {ξ}_{s}^{3}}{1 + {ξ}_{s} + {ξ}_{s}^{2}} + \frac{5}{} \cdot \frac{{F}_{x}}{{K}_{β}} \cdot \frac{1 + 2 {ξ}_{s} + 3 {ξ}_{s}^{2} + 4 {ξ}_{s}^{3}}{{( 1 + {ξ}_{s} + {ξ}_{s}^{2} )}^{2}} \} {F}_{y} \qquad ( 3 )$$

where Fx represents longitudinal force, Fy represents lateral force, K_{β} represents tire cornering power, and L represents tire contact length.

By reordering the above Expression (3) using the grip margin ε, and defining the ratio between the pneumatic trail obtained by dividing the self-aligning torque by the lateral force and the tire contact length as the physical quantity MF, the physical quantity MF can be expressed as in the following Expression (4).

$$MF = \frac{{T}_{sat}}{\cdot {F}_{y}} = ɛ \cdot \frac{2}{1 + {ɛ}^{1 / 3} + {ɛ}^{2 / 3}} + \frac{3}{5} \cdot \frac{{F}_{y}}{{K}_{β}} \cdot \frac{1 + 2 \cdot {ɛ}^{1 / 3} + 3 \cdot {ɛ}^{2 / 3} + 4 \cdot ɛ}{{( 1 + {ɛ}^{1 / 3} + {ɛ}^{2 / 3} )}^{2}} \qquad ( 4 )$$

Now, the value of the cornering power K_{β} changes depending on the type of tire and the load on wheel. Accordingly, when a fixed value is used, the physical quantity MF changes and errors are generated. On the other hand, in the uncontrolled drive state while traveling, the longitudinal force Fx of the tire is a very small value no greater than the predetermined value (|Fx|≤A). The constant A is the threshold value, and is a setting value set in advance as a value in the proximity of zero, around a sensor noise amplitude. Accordingly, the effects of the longitudinal force Fx of the tires while traveling in an uncontrolled drive state presumably are small.

Accordingly, in the present embodiment, conditions where the longitudinal force Fx is a very small value no greater than the predetermined value (|Fx|≤A) are set as threshold value conditions for the uncontrolled drive state, and the physical quantity MF when the threshold value conditions are satisfied is calculated. When the longitudinal force Fx satisfies the threshold value conditions, the second term of Expression (4) can be set to approximately zero, and the effects of the cornering power K_{β} can be removed. That is to say, when traveling in the uncontrolled drive state, the physical quantity calculating unit 14 can omit the second term of Expression (4), and calculate the physical quantity MF from the grip margin ε.

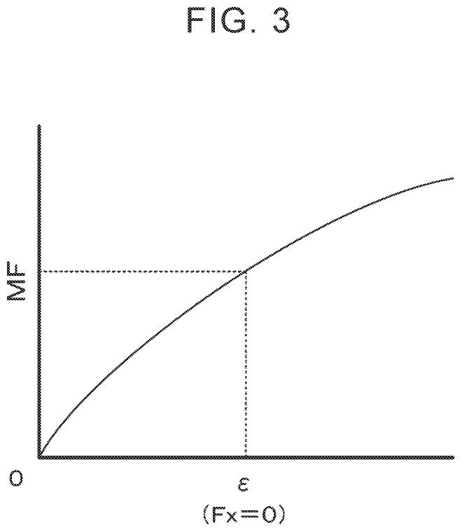

The physical quantity calculating unit 14 may store a correlative relation between the grip margin ε and the physical quantity MF as a table in memory in advance, as illustrated in FIG. 3, and read out and derive the physical quantity MF corresponding to each piece of data of the grip margin ε from the stored table.

The tire contact length calculating unit 16 calculates the tire contact length L. The tire contact length calculating unit 16 calculates the tire contact length L using data of the self-aligning torque (Tsat) acquired by the self-aligning torque acquiring unit 11A, data of the physical quantity MF calculated by the physical quantity calculating unit 14, and data detected as the tire generated force (lateral force Fy). The tire contact length L can be calculated by the following Expression (5). The tire contact length calculating unit 16 has functions of sequentially storing the calculated tire contact length L in the tire contact length storage unit 17. Note that the tire contact length calculating unit 16 is able to calculate the tire contact length L for each wheel that the vehicle is provided with. Also, the tire contact length calculating unit 16 is an example of a contact length estimating unit according to the present disclosure.

$$∠ = \frac{{T}_{sat}}{{F}_{y} \cdot MF} \qquad ( 5 )$$

The tire contact length storage unit 17 sequentially stores the tire contact length L calculated by the tire contact length calculating unit 16. Note that the tire contact length storage unit 17 is able to store the tire contact length L for each wheel that the vehicle is provided with.

Thus, the tire contact length estimating unit 10 estimates the tire contact length L at the current point in time, using the current self-aligning torque, the tire generated force, and the road surface friction coefficient. That is to say, the tire contact length estimating unit 10 calculates the current generated friction coefficient using the data of the tire generated force at the generated friction coefficient calculating unit 12, and calculates the grip margin ε at the grip margin calculating unit 13. The tire contact length estimating unit 10 then calculates the physical quantity MF at the physical quantity calculating unit 14, and calculates the tire contact length L at the tire contact length calculating unit 16, which is stored in the tire contact length storage unit 17.

Cornering Power Estimating Unit

The cornering power estimating unit 23 estimates the cornering power using the data acquired by the data acquiring unit 11 and the tire contact length L estimated by the tire contact length estimating unit 10.

FIG. 4 illustrates an example of a schematic configuration of the cornering power estimating unit 23. The cornering power estimating unit 23 is provided with the data acquiring unit 11, the generated friction coefficient calculating unit 12, the grip margin calculating unit 13, and a cornering power calculating unit 25, as illustrated in FIG. 4. Note that the cornering power estimating unit 23 is an example of a cornering power estimating unit according to the present disclosure.

The cornering power estimating unit 23 is able to acquire data from the data acquiring unit 11. That is to say, the self-aligning torque acquiring unit 11A acquires data indicating the self-aligning torque (Tsat), the road surface friction coefficient acquiring unit 11B acquires data of the road surface friction coefficient, the longitudinal force acquiring unit 11C acquires data of the longitudinal force Fx, the load-on-wheel acquiring unit 11D acquires data of the load on wheel Fz, and the lateral force acquiring unit 11E acquires data of the lateral force Fy. The generated friction coefficient calculating unit 12 calculates the generated friction coefficient as described above, and the grip margin calculating unit 13 calculates the current grip margin ε.

The cornering power calculating unit 25 calculates the cornering power K_{β} using the tire contact length L stored in the tire contact length storage unit 17, the self-aligning torque (Tsat) acquired by the self-aligning torque acquiring unit 11A, the data of the longitudinal force Fx acquired by the longitudinal force acquiring unit 11C, the grip margin ε calculated by the grip margin calculating unit 13, and the lateral force Fy acquired at the lateral force acquiring unit 11E.

By reordering into an expression regarding the cornering power K_{β}, the above Expression (4) can be expressed as the following Expression (6).

$${K}_{β} = [ \frac{{T}_{sat}}{L \cdot {F}_{y}} - \frac{2 \cdot ɛ}{1 + {ɛ}^{1 / 3} + {ɛ}^{2 / 3}} ] / [ \frac{3}{5} \cdot \frac{{F}_{x} \cdot ( 1 + 2 \cdot {ɛ}^{1 / 3} + 3 \cdot {ɛ}^{2 / 3} + 4 \cdot ɛ )}{{( 1 + {ɛ}^{1 / 3} + {ɛ}^{2 / 3} )}^{2}} ] \qquad ( 6 )$$

The cornering power calculating unit 25 substitutes the tire contact length L, the self-aligning torque Tsat, the longitudinal force Fx, the grip margin ε, and the lateral force Fy into the above Expression (6), and calculates the cornering power K_{β}.

Note that the cornering power calculating unit 25 computes the cornering power K_{β} using the tire contact length L stored immediately before or the newest tire contact length L. That is to say, the cornering power calculating unit 25 has a function to acquire, out of the tire contact lengths L estimated and stored by the tire contact length estimating unit 10, the tire contact length L stored immediately before or the newest tire contact length L from the tire contact length storage unit 17. Accordingly, the cornering power K_{β} can be calculated more in line with the state of the tire while traveling, as compared to when calculating the cornering power using the tire contact length L as a fixed value.

The cornering power calculating unit 25 calculates the cornering power K_{β} of the tire in the controlled drive state, using the tire contact length L calculated in a tire state that is the uncontrolled drive state. Now, the cornering power K_{β} presumably changes in accordance with increase and decrease of controlled drive force in the controlled drive state, but changes in the cornering power K_{β} are small between the uncontrolled drive state and the controlled drive state with margin in the tire grip. Accordingly, the effects of calculating the cornering power K_{β} of the tire in the controlled drive state using the tire contact length L calculated in the uncontrolled drive state on estimation of the cornering power K_{β} is presumably sufficiently small between the uncontrolled drive state and the controlled drive state.

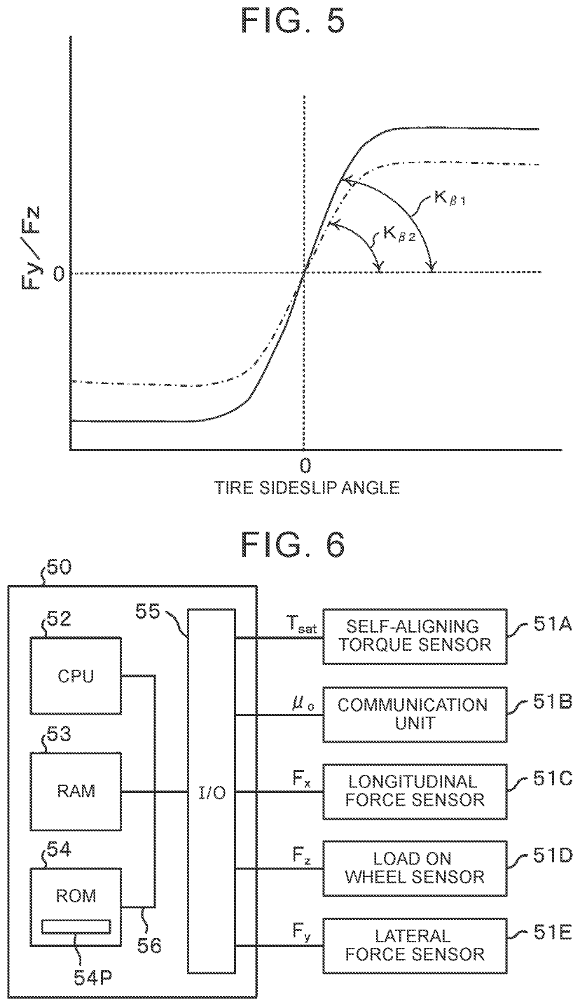

For example, FIG. 5 illustrates an example of the tire lateral force characteristics as to the tire sideslip angle when the tire slip ratios is λ=0.0 and 0.25. In FIG. 5, the tire lateral force characteristics of tire slip ratio λ=0.0 without controlled drive are indicated by a continuous line, and the tire lateral force characteristics of tire slip ratio λ=0.25 in a controlled drive state in the proximity of the limit of frictional force of the tire are indicated by a long dashed short dashed line. In the characteristics of the tire slip ratios λ=0.0 and 0.25, the proportion of the inclination thereof that is tire cornering power K_{β1} as to K_{β2} is approximately 0.7 (i.e., K_{β}/K_{β1}), as illustrated in FIG. 5. Considering that the slip ratio λ is normally 0.1 at the largest, the effects on the cornering power estimation value from no controlled drive (uncontrolled drive state) to controlled drive are sufficiently small.

Thus, the cornering power estimating unit 23 calculates the cornering power K_{β} at the current point in time using the estimated tire contact length L, the self-aligning torque Tsat that is acquired, the longitudinal force Fx, the grip margin ε, and the lateral force Fy.

Output Unit

The output unit 24 outputs the cornering power K_{β} estimated by the cornering power estimating unit 23. The output unit 24 outputs the cornering power K_{β} estimated by the cornering power estimating unit 23, and performs data output to external devices and data display output to a display device such as a monitor or the like.

The tire state estimating device 1 described above can be realized by a configuration including a computer as an execution device that executes processing to realize the above-described functions.

FIG. 6 illustrates an example of realizing the tire state estimating device 1 by a configuration including a computer. The tire state estimating device 1 realized by a configuration including a computer is provided with a device main unit 50. The device main unit 50 is provided with a central processing unit (CPU) 52, random access memory (RAM) 53, read only memory (ROM) 54, and an input/output interface (I/O) 55. The CPU 52, the RAM 53, the ROM 54, and the I/O 55 are a configuration connected to each other via a bus 56 so as to be able to exchange data and commands.

Connected to the I/O 55 are a self-aligning torque sensor 51A, a communication unit 51B, a longitudinal force sensor 51C, a load on wheel sensor 51D, and a lateral force sensor 51E.

The self-aligning torque sensor 51A detects the self-aligning torque (Tsat) in the vehicle. Accordingly, the self-aligning torque sensor 51A functions as the self-aligning torque acquiring unit 11A.

The communication unit 51B exchanges data with an external device by wireless communication, for example. Here, the communication unit 51B acquires data of the road surface friction coefficient that is a known friction coefficient while currently traveling, by communication. Accordingly, the communication unit 51B functions as the road surface friction coefficient acquiring unit 11B.

Each of the longitudinal force sensor 51C, the load on wheel sensor 51D, and the lateral force sensor 51E detects the tire generated forces (Fx, Fy, Fz). Accordingly, the longitudinal force sensor 51C, the load on wheel sensor 51D, and the lateral force sensor 51E function as the longitudinal force acquiring unit 11C, the load-on-wheel acquiring unit 11D, and the lateral force acquiring unit 11E.

Also, the ROM 54 stores a tire state estimating program 54P for causing the computer to function as the tire state estimating device 1. The CPU 52 reads the tire state estimating program 54P from the ROM 54 and loads the tire state estimating program 54P to the RAM 53, and executes the processing thereof. Accordingly, the computer executing the tire state estimating program 54P operates as a tire state estimating device. Note that the ROM 54 stores information indicating the correlative relation between the grip margin ε and the physical quantity MF as a table (FIG. 3). Also note that the tire state estimating program 54P and the table may be provided by a recording medium such as a compact disc (CD)-ROM or the like.

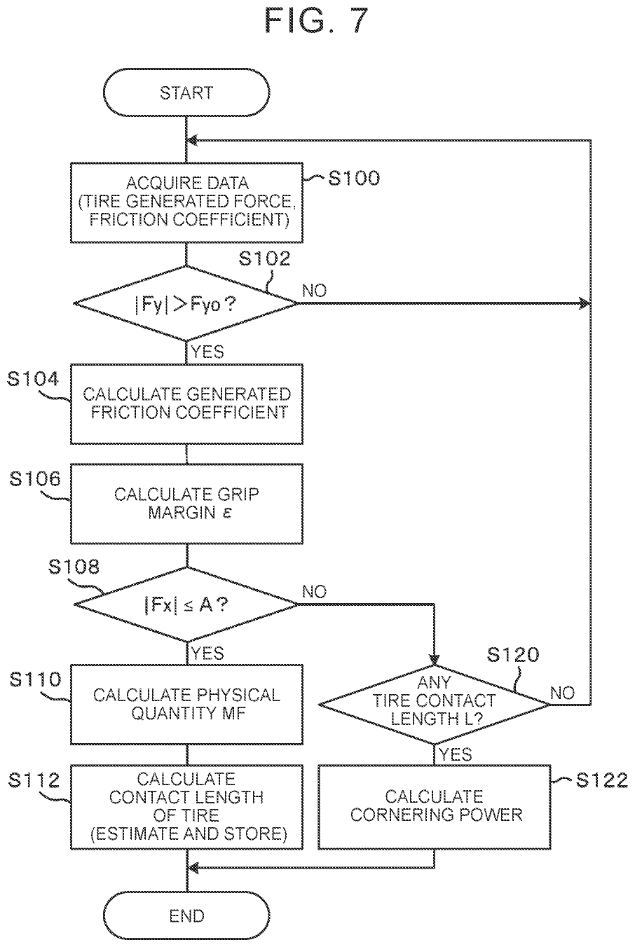

FIG. 7 shows an example of a flow of processing of the tire state estimating program 54P. The processing routine shown in FIG. 7 is periodically executed by the CPU 52. The tire state estimating program 54P is an example of a tire state estimating program according to the present disclosure. The processing of the tire state estimating program 54P in FIG. 7 that is executed by the device main unit 50 is an example of a tire state estimating method according to the present disclosure.

In step S100, the CPU 52 acquires data of each of the road surface friction coefficient and the tire generated force (self-aligning torque Tsat, longitudinal force Fx, lateral force Fy, and load on wheel Fz).

Next, the CPU 52 determines in step S102 whether the data of the lateral force Fy in the data acquired in step S100 exceeds a magnitude set in advance. The processing in step S102 is processing to determine whether the lateral force Fy satisfies turning conditions (|Fy|>Fyo) set in advance that will affect the cornering power K_{β}. The CPU 52 transitions to processing of step S104 when a positive determination is made in step S102, and returns the processing to step S100 when a negative determination is made.

When the lateral force Fy of the tire satisfies the turning conditions of the vehicle, the CPU 52 makes a positive determination in step S102, and calculates the generated friction coefficient using the above Expression (1A) in step S104.

Next, the CPU 52 calculates the grip margin ε in step S106, using the above Expression (2).

Next, in step S108, the CPU 52 determines whether the data of the longitudinal force Fx in the data acquired in step S100 is no greater than a magnitude set in advance. The processing in step S108 is processing of determining whether the longitudinal force Fx satisfies threshold value conditions (|Fx|≤A) set in advance as the uncontrolled drive state. The CPU 52 transitions the processing to step S110 when the determination in step S108 is positive, and transitions the processing to step S120 when the determination in step S108 is negative.

Next, the CPU 52 calculates the physical quantity MF using the above Expression (4) in step S110. The CPU 52 then in the next step S112 estimates the tire contact length L by calculating the contact length of the tire using the above Expression (5), stores the tire contact length L in the RAM 53 (tire contact length storage unit 17), and ends this processing routine.

On the other hand, when the longitudinal force Fx of the tire does not satisfy the threshold value conditions and the determination in step S108 is negative, the tire is presumed to be in a controlled drive state, and accordingly processing for estimating the cornering power K_{β} is executed. That is to say, in step S120, the CPU 52 determines whether the estimated tire contact length L is stored in the RAM 53 (tire contact length storage unit 17). The CPU 52 transitions the processing to step S122 when the determination in step S120 is positive, and returns the processing to step S100 when the determination in step S120 is negative.

When the estimated tire contact length L is stored, the CPU 52 makes a positive determination in step S120. The CPU 52 then in step S122 calculates the cornering power K_{β} using the above Expression (6), outputs the calculated cornering power K_{β}, and ends this processing routine.

As described above, according to the present embodiment, the cornering power K_{β} is estimated using the tire contact length L in an uncontrolled drive state. Accordingly, the cornering power K_{β} can be calculated that is in line with the state of the tire that varies from moment to moment while traveling, as compared to when estimating the cornering power K_{β} with the tire contact length L as a fixed value.

### Second Embodiment

Next, a second embodiment will be described. The second embodiment is an arrangement for determining types of tires using the estimated cornering power K_{β}. Note that the second embodiment has the same configuration as the first embodiment, and accordingly, portions that are the same are denoted by the same signs, and detailed description thereof will be omitted.

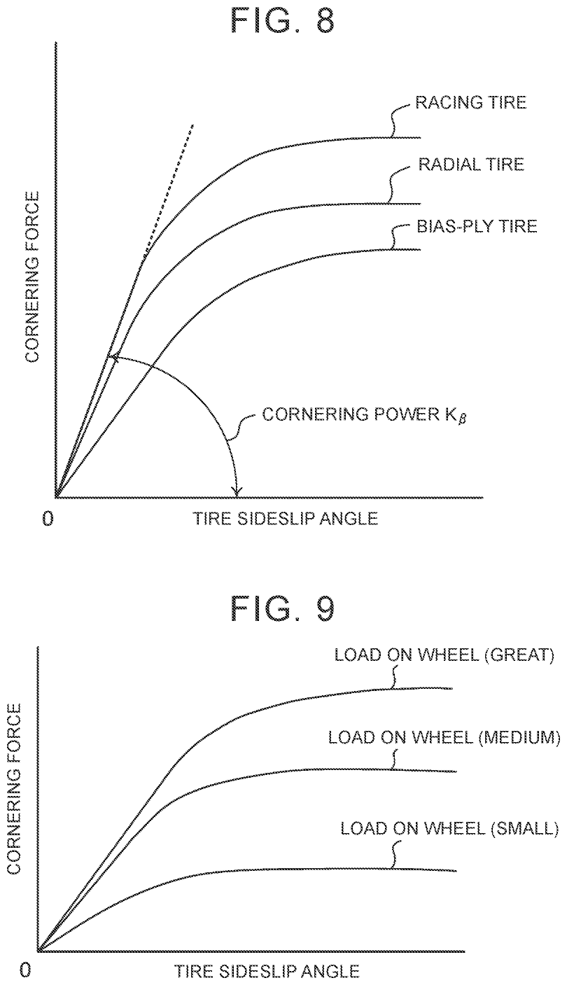

Now, the cornering power K_{β} sometimes has different values depending on the type of the tire. FIG. 8 illustrates an example of cornering force characteristics as to tire sideslip angle for various types of tires, under the same load on wheel. As shown in FIG. 8, the cornering power K_{β} that is the inclination of the cornering force characteristics differs for each type of tire. In the example illustrated in FIG. 8, the cornering power K_{β} increases in the order of bias-ply tire, radial tire, and racing tire. Accordingly, when the cornering power K_{β} can be identified, the type of tire can be identified.

On the other hand, the cornering force Fc changes depending on the load on wheel Fz even though the type of tire is the same. FIG. 9 illustrates an example of cornering force characteristics as to tire sideslip angle for the same type of tire, e.g., the same tire. As illustrated in FIG. 9, the cornering power K_{β} differs for each load on wheel Fz. In the example illustrated in FIG. 9, the cornering power K_{β} increases as the load on wheel Fz of the tire increases, in the order of when the load on wheel Fz is small, when the load on wheel Fz is medium level, and when the load on wheel Fz is great.

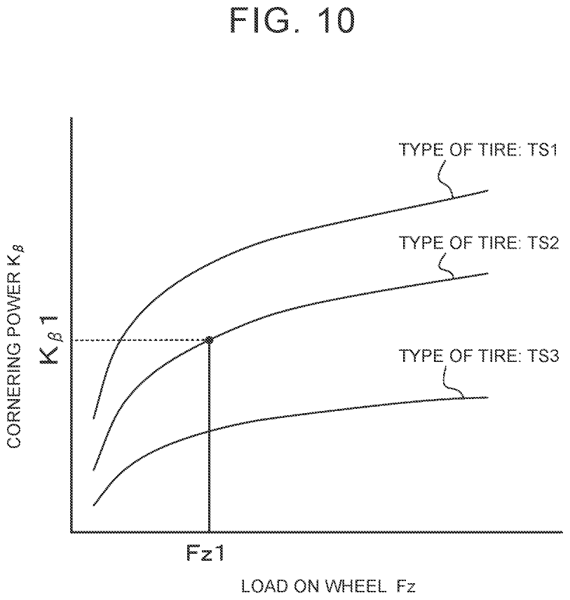

Accordingly, in the present embodiment, the characteristics of the cornering power K_{β} as to the load on wheel is stored in advance for each type of tire, and the type of tire is determined based on the estimation value of the cornering power K_{β} and the acquired load on wheel. FIG. 10 illustrates an example of tire characteristics regarding the cornering power K_{β} as to the load on wheel, by the type of tire. As illustrated in FIG. 10, the cornering power K_{β} differs for each load on wheel Fz. In the example in FIG. 10, the tire characteristics of each of tire types TS1, TS2, and TS3 are illustrated. For example, when the cornering power K_{β} is estimation value K_{β}1, and the load on wheel Fz is load on wheel Fz1, the type of tire can be determined to be TS2.

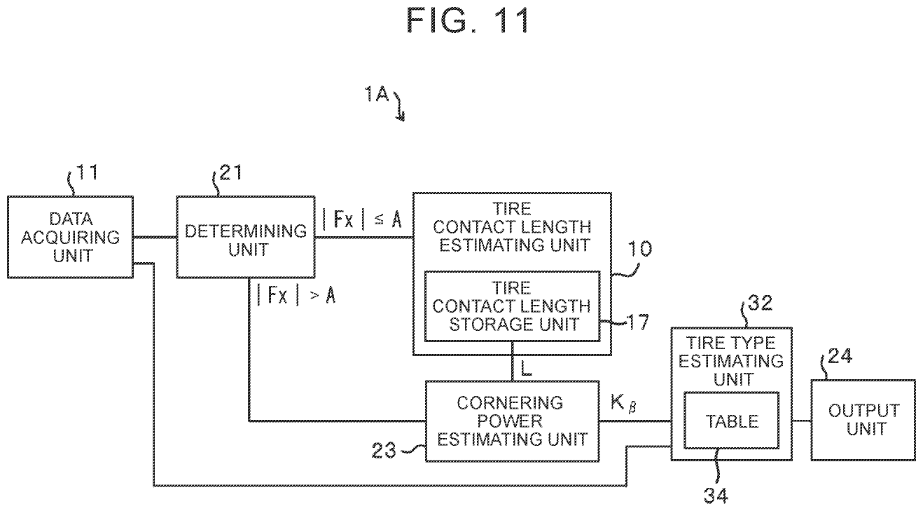

FIG. 11 illustrates an example of the schematic configuration of a tire state estimating device 1A according to the second embodiment. The tire state estimating device 1A is the tire state estimating device 1 illustrated in FIG. 1 to which a tire type estimating unit 32 is further provided, as illustrated in FIG. 11. Note that the configurations other than the tire type estimating unit 32 are the same as the configurations of the tire state estimating device 1 illustrated in FIG. 1, and accordingly detailed description will be omitted. The tire type estimating unit 32 is an example of a tire type estimating unit according to the present disclosure.

The tire type estimating unit 32 determines the type of tire using the cornering power K_{β} and the load on wheel Fz. The tire type estimating unit 32 is provided with a table 34 that stores tire characteristics showing the correlative relation between the load on wheel and the cornering power K_{β} for each type of tire (FIG. 10). That is to say, the tire type estimating unit 32 obtains the correlative relation between the load on wheel and the cornering power K_{β} for each tire type in advance, and stores this as the table 34. The tire type estimating unit 32 reads out the cornering power K_{β} calculated by the cornering power estimating unit 23 and the load on wheel Fz acquired by the load-on-wheel acquiring unit 11D, and determines the type of tire corresponding to the cornering power K_{β} and the load on wheel Fz, using the table 34. Note that when the value of the cornering power K_{β} and the value of the load on wheel Fz do not match any tire characteristics, tire characteristics in the proximity may be selected.

Now, in recent years, vehicles provided with anti-lock braking systems (ABS) installed are in widespread use. An ABS performs control so that the slip ratio is maintained within a predetermined range, and performs control so that the slip ratio of the wheels is near a slip ratio determined in advance, for example. The slip ratio is preferably set such that the longitudinal force of the tires is greatest particularly when braking of the vehicle is performed, but the slip ratio at which the longitudinal force of the tire is greatest differs depending on the type of tire.

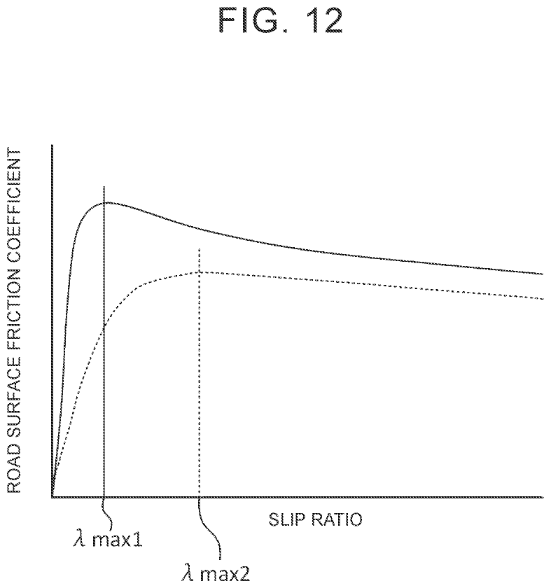

FIG. 12 illustrates an example of the relation between the tire slip ratio and the road surface friction coefficient. In the example illustrated in FIG. 12, slip ratio characteristics when a vehicle traveling over a dry road surface has summer tires installed are indicated by a continuous line, and slip ratio characteristics when the vehicle has winter tires (so-called studless tires) installed are indicted by a dotted line. As illustrated in FIG. 12, the slip ratio λmax1 at which the longitudinal force of the tire is greatest for the summer tire is smaller than the slip ratio λmax2 at which the longitudinal force of the tire is greatest for the winter tire.

According to the present embodiment, the type of tire can be identified from the estimated cornering power K_{β}. The value of the road surface friction coefficient can also be acquired. Accordingly, a slip ratio at which the longitudinal force is greatest can be set by the ABS in accordance with the value of the acquired road surface friction coefficient and the results of determining the type of tire, and braking capabilities of the vehicle using the ABS can be improved.

As described above, according to the present embodiment, the cornering power K_{β} can be estimated, and the estimated cornering power K_{β} and the acquired load on wheel Fz can be used to determine the type of tire.

Although technology of the present disclosure has been described above by way of embodiments, the technical scope of the technology of the present embodiment is not limited to the scope described in the above embodiments. Various modifications and improvements may be made to the above embodiments without departing from the essence thereof, and embodiments to which these modifications and improvements are made are encompassed by the technical scope of the technology of the disclosure.

Also, although processing carried out by executing a program stored in an auxiliary storage device has been described in the above embodiments, at least part of the processing of the program may be realized by hardware.

Further, processing of the above embodiments may be stored in a storage medium or the like such as an optical disc or the like, as a program, and distributed.

In the above embodiments, the term “processor” means a processor in the broad sense, including general-purpose processors (e.g., CPUs, etc.) and dedicated processors (e.g., graphics processing units (GPU), application-specific integrated circuits (ASIC), field-programmable gate arrays (FPGA), programmable logic devices, etc.).

The operations of the processor in the above embodiments are not limited to being carried out by a single processor, and may be carried out by a plurality of processors at physically remote locations collaborating. Also, the order of the operations of the processor is not limited to just the order set forth in the above embodiments, and may be changed as appropriate.

All Literature, patent applications, and technical standards described in the present specification are incorporated by reference in the present specification to the same extent that the individual Literature, patent applications, and technical standards would be included by reference through specific and individual statement of such inclusion thereof.

What is claimed is:

1. A tire state estimating device comprising: an electronic control unit, wherein:
the electronic control unit is configured to acquire generated force of a tire;
the electronic control unit is configured to acquire a friction coefficient between the tire and a road surface;
the electronic control unit is configured to derive a grip margin of the tire, based on the generated force of the tire that is acquired and the friction coefficient that is acquired;
the electronic control unit is configured to estimate a contact length of the tire, based on the generated force of the tire that is acquired and the grip margin that is derived, in an uncontrolled drive state, the uncontrolled drive state being a state in which, of the generated force of the tire, generated force generated in a front-rear direction of the tire is no greater than a threshold value set in advance; and
the electronic control unit is configured to estimate a cornering power of the tire, based on the contact length of the tire that is estimated, and the generated force of the tire that is acquired.

2. The tire state estimating device according to claim 1, wherein:
the electronic control unit is configured to acquire, as the generated force of the tire, a self-aligning torque generated at the tire, a front-rear direction state generated at the tire, a lateral-direction state generated at the tire, and a load-on-wheel state generated at the tire;
the electronic control unit is configured to acquire a coefficient of static friction as a first friction coefficient, and a coefficient of dynamic friction as a second friction coefficient, the coefficient of dynamic friction being a coefficient of dynamic friction in a moving state, in which the tire and the road surface are relatively moving, the coefficient of dynamic friction being derived using the front-rear direction state, the lateral-direction state, and the load-on-wheel state that are acquired;
the electronic control unit is configured to derive the grip margin of the tire based on a ratio of the first friction coefficient and the second friction coefficient;
the electronic control unit is configured to estimate the contact length of the tire based on the self-aligning torque, the front-rear direction state, the lateral-direction state, and the grip margin; and
the electronic control unit is configured to estimate the cornering power of the tire based on the contact length of the tire that is estimated, the self-aligning torque, the front-rear direction state, the lateral-direction state, and the grip margin.

3. The tire state estimating device according to claim 2, wherein the electronic control unit is configured to derive the cornering power of the tire using the following Expression
$$\begin{matrix} & ( Expression ) \\ {K}_{β} = [ \frac{{T}_{sat}}{L \cdot {F}_{y}} - \frac{2 \cdot ɛ}{1 + {ɛ}^{1 / 3} + {ɛ}^{2 / 3}} ] / [ \frac{3}{5} \cdot \frac{{F}_{x} \cdot ( 1 + 2 \cdot {ɛ}^{1 / 3} + 3 \cdot {ɛ}^{2 / 3} + 4 \cdot ɛ )}{{( 1 + {ɛ}^{1 / 3} + {ɛ}^{2 / 3} )}^{2}} ] & \end{matrix}$$
in which Tsat represents the self-aligning torque, Fx represents the front-rear direction state, Fy represents the lateral-direction state, ε represents the grip margin of the tire, and L represents the contact length of the tire.

4. The tire state estimating device according to claim 1, wherein the electronic control unit is configured to estimate, regarding a plurality of different types of tires, a type of tire corresponding to the generated force that is acquired and the cornering power that is estimated, based on a correlative relation between generated force of each tire and cornering power of each tire, stored by type.

5. A control method of a tire state estimating device, the tire state estimating device including a processor, the control method comprising:
acquiring, by the processor, generated force of a tire;
acquiring, by the processor, a friction coefficient between the tire and a road surface;
deriving, by the processor, a grip margin of the tire, based on the generated force of the tire that is acquired and the friction coefficient that is acquired;
estimating, by the processor, a contact length of the tire, based on the generated force of the tire that is acquired and the grip margin that is derived, in an uncontrolled drive state, the uncontrolled drive state being a state in which, of the generated force of the tire, generated force generated in a front-rear direction of the tire is no greater than a threshold value set in advance; and
estimating, by the processor, a cornering power of the tire, based on the contact length of the tire that is estimated, and the generated force of the tire that is acquired.

6. A non-transitory storage medium storing instructions that are executable by one or more processors and that cause the one or more processors to perform functions comprising:
acquiring generated force of a tire;
acquiring a friction coefficient between the tire and a road surface;
deriving a grip margin of the tire, based on the generated force of the tire that is acquired and the friction coefficient that is acquired;
estimating a contact length of the tire, based on the generated force of the tire that is acquired and the grip margin that is derived, in an uncontrolled drive state, the uncontrolled drive state being a state in which, of the generated force of the tire, generated force generated in a front-rear direction of the tire is no greater than a threshold value set in advance; and
estimating a cornering power of the tire, based on the contact length of the tire that is estimated, and the generated force of the tire that is acquired.
